(19) United States
(12) Patent Application Publication
(10) Pub. No.: US 2014/0113123 A1
(43) Pub. Date: Apr. 24, 2014

(54) BINDER FOR MINERAL AND/OR ORGANIC FIBER MAT, AND PRODUCTS OBTAINED

(71) Applicants: Katarzyna CHUDA, Villejuif (FR); Aurelien Couraud, Thure (FR)

(72) Inventors: Katarzyna CHUDA, Villejuif (FR); Aurelien Couraud, Thure (FR)

(73) Assignee: SAINT-GOBAIN ADFORS, Chambery (FR)

(21) Appl. No.: 14/127,031

(22) PCT Filed: Jun. 14, 2012
(86) PCT No.: PCT/FR12/51331

§ 371 Date: Dec. 17, 2013

(30) Foreign Application Priority Data
Jun. 17, 2011 (FR) 11 55327

(51) Int. Cl. C03C 25/34

(52) U.S. Cl. CPC C03C 25/34
USPC 428/219; 442/177; 524/74; 524/72; 524/76; 524/75; 524/56

(57) ABSTRACT

The present invention concerns an aqueous binder for a fiber mat, in particular mineral fibers, which comprises, in parts by weight:
50 to 95 parts of at least one lignosulfonic acid salt;
5 to 50 parts of at least one thermosetting resin selected from phenolic resins and urea-formaldehyde resins; and
5 to 20 parts of a curing catalyst selected from compounds containing phosphorus and sulfates per 100 parts of lignosulfonic acid salt and of thermosetting resin.

It also concerns the products resulting from treatment of the fibers, especially mineral fibers, with said binder.

The present invention relates to the field of mats comprising mineral and/or organic fibers bonded by a formaldehyde-free organic binder, in particular glass or rock fibers.

More particularly, the invention relates to a binder that can be heat-cured that comprises at least one lignosulfonic acid salt, at least one thermosetting resin and at least one catalyst for curing said compounds, as well as to mats of such fibers that result therefrom.

Mineral fiber mats (also known as “non-wovens” or “veils”) can be manufactured using known processes operating by means of dry or wet procedures.

In the dry procedure, molten mineral matter contained in a furnace is routed to an assembly of dies from which filaments flow under gravity and are stretched by a gaseous fluid. The mineral filaments are harvested on a conveyer where they become entangled, forming a mat.

A binder is applied to the upper face of the mat thus formed using suitable equipment, usually by curtain coating, and the excess binder is eliminated by suction from the opposite face. The mat then enters equipment containing hot air wherein the temperature, of the order of 200° C. to 250° C., can eliminate water and cure the binder over a very short time period, of the order of about ten seconds to 1 minute; the mineral fiber mat is then collected in the form of a roll.

In the wet procedure, the mat is obtained from an aqueous dispersion of cut mineral fibers that is deposited by means of a forming head onto a conveyor provided with perforations; water is extracted through the conveyor by means of a suction box. The cut mineral fibers remaining on the conveyor form a mat that is treated under conditions that are the same as those described for the dry procedure.

In the procedures mentioned above, the binder acts to bind the mineral fibers together and to provide the mat containing them with mechanical properties that are suitable for the desired usage, in particular sufficient rigidity to be able to be handled easily, in particular without running the risk of being torn.

The binder to be applied to the mineral fibers is generally in the form of an aqueous solution comprising at least one thermosetting resin and additives such as a curing catalyst for the resin, an adhesion-promoting silane, a water repellent, etc.

The most widely used thermosetting resins are resins based on formaldehyde, in particular phenolic resins belonging to the resol family, urea-formaldehyde resins and melamine-formaldehyde resins. Such resins have good curing properties under the thermal conditions mentioned above, are soluble in water, have good affinity for the mineral fibers and are also relatively cheap.

However, such resins tend to contain free formaldehyde, the presence of which is not wanted due to undesirable effects from a human health and environmental standpoint. Environmental protection regulations have been becoming stricter for a number of years; this has obliged resin and fiber mat manufacturers to investigate solutions that can be used to reduce the quantity of free formaldehyde still further.

Solutions that replace formaldehyde-based resins for binding mineral fibers are known and are based on the use of a carboxylic acid polymer, in particular an acrylic acid polymer, in combination with a β-hydroxylamide and a monomeric, at least trifunctional, carboxylic acid (U.S. Pat. No. 5,340,868).

Adhesive compositions have been proposed that comprise a polycarboxylic polymer, a polyol and a catalyst, wherein the catalyst is a phosphorus-containing catalyst (U.S. Pat. No. 5,318,990, U.S. Pat. No. 5,661,213, U.S. Pat. No. 6,331,350, US 2003/0008978), a fluoroborate (U.S. Pat. No. 5,977,232) or a cyanamide, a dicyanamide or a cyanoguanidine (U.S. Pat. No. 5,932,689).

Adhesive compositions have also been described that comprise an alkanolamine comprising at least two hydroxyl groups and a polycarboxylic polymer (U.S. Pat. No. 6,071,994, U.S. Pat. No. 6,099,773, U.S. Pat. No. 6,146,746, US 2002/0091185) associated with a copolymer (U.S. Pat. No. 6,299,936), a cationic, amphoteric or non-ionic surfactant (US 2002/0188055) or a silane (US 2004/0002567).

In US 2005/0215153, the adhesive composition is formed from a pre-binder containing a carboxylic acid polymer and a polyol, with a dextrin as a co-binder.

Further, adhesive compositions based on heat-curable saccharides are known.

In U.S. Pat. No. 5,895,804, the adhesive composition comprises a polycarboxylic polymer containing at least two carboxylic acid functional groups and having a molecular weight of at least 1000, and a polysaccharide with a molecular weight of at least 10 000.

WO 2009/080938 describes a sizing composition for mineral wool or a veil of mineral fibers comprising at least one monosaccharide and/or at least one polysaccharide and at least one polycarboxylic organic acid with a molar mass of 1000 or less.

More particularly, the present invention is concerned with mineral fiber mats in the form of veils that are intended for the manufacture of bituminous roofing membranes.

Thus, the aim of the invention is to provide a binder for mats of mineral and/or organic fibers, in particular glass or rock fibers, which has a reduced content of free formaldehyde and which has good resistance to aging in a moist medium and to the application of molten bitumen, while having satisfactory mechanical properties, in particular good tensile strength.

To this end, the present invention proposes an aqueous binder for fibers, in particular mineral fibers, which comprises, in parts by weight:
50 to 95 parts of at least one lignosulfonic acid salt;
5 to 50 parts of at least one thermosetting resin selected from phenolic resins and urea-formaldehyde resins; and
5 to 20 parts of a curing catalyst selected from compounds containing phosphorus and sulfates per 100 parts of lignosulfonic acid salt and of thermosetting resin.

The lignosulfonic acid salt is generally a complex mixture of a plurality of lignosulfonic acids in the salt form, generally known as “lignosulfonate”. Lignosulfonates are by-products from the treatment of wood for the manufacture of paper pulp using the so-called “sulfite” process. Depending on the nature of the counter-ion employed, that process, which uses a sulfite or a bisulfite, can be used to produce sodium, calcium, potassium, magnesium or ammonium lignosulfonates. Ammonium lignosulfonate is the preferred lignosulfonic acid salt in the invention.

Lignosulfonates can provide the binder with good fire resistance.

The phenolic resin in accordance with the invention is selected from resol-type resins obtained by reaction of a phenolic compound and an aldehyde in the presence of a basic catalyst, in an aldehyde/phenolic compound molar ratio of greater than 1, preferably ranging from 2 to 5.

The phenolic compound may, for example, be phenol, a cresol such as o-cresol, m-cresol or p-cresol, resorcinol and mixtures of these compounds, preferably phenol.

By way of example of a basic catalyst, mention may be made of triethylamine, lime (CaO) and alkali metal or alkaline-earth metal hydroxides, for example sodium hydroxide, potassium hydroxide, calcium hydroxide or barium hydroxide. Sodium hydroxide and lime are preferred.

The preferred phenolic resin is a phenol-formaldehyde resol.

The urea-formaldehyde resin in accordance with the invention is obtained conventionally by condensation of urea and formaldehyde in several stages, in the presence of a base, in a formaldehyde/urea molar ratio which ranges from 1.0 to 2.5.

In the binder, the lignosulfonic acid salt preferably represents at least 60% of the weight of the mixture constituted by the lignosulfonic acid salt and the thermosetting resin, advantageously at least 70%.

The curing catalyst acts to accelerate the formation of ester bonds between the lignosulfonic acid salt and the thermosetting resin under the effect of heat that leads to the production of a polymeric matrix in the final binder. Said polymeric matrix can be used to establish bonds at the junction points of the fibers in the mineral wool. The catalyst can also be used to adjust the binder curing onset temperature.

As already mentioned, the curing catalyst is selected from compounds containing phosphorus and sulfates.

Examples that may be cited are alkali metal hypophosphite salts, alkali metal phosphites, alkali metal polyphosphates, alkali metal hydrogen phosphates, phosphoric acids and alkylphosphonic acids, in which the alkali metal is preferably sodium or potassium; ammonium phosphates, in particular diammonium phosphate; and ammonium sulfate. Sodium hypophosphite and diammonium phosphate are particularly preferred.

Preferably, the quantity of curing catalyst in the binder represents at most 20% of the weight of the lignosulfonic acid salt and of the thermosetting resin, advantageously at most 15% and still more preferably at most 10%.

The binder may also comprise up to 15 parts by weight of a vinyl acetate polymer per 100 parts by weight of mixture constituted by the lignosulfonic acid salt and the thermosetting resin, preferably up to 10 parts.

The vinyl acetate polymer may be a homopolymer or a copolymer, for example at least one hydrophobic monomer such as ethylene, propylene, butylene, styrene or vinyl chloride, in particular an ethylene-vinyl acetate copolymer (EVA).

The binder may also comprise up to 20 parts by weight of an oligosaccharide which contains at most 10 saccharide motifs. In the context of the present invention, monosaccharides should be considered to be an integral part of the oligosaccharides.

The oligosaccharide is selected from monosaccharides, preferably containing 5 to 7 carbon atoms, in particular glucose, mannose, galactose and fructose; disaccharides such as saccharose, maltose, cellobiose, trehalose, lactose, gentobiose or melibiose; trisaccharides such as raffinose or gentianose; tetrasaccharides such as stachyose; and fructose polymers, especially fructans and in particular inulins (these fructose polymers containing at most 10 saccharide motifs, as indicated above), and mixtures of these compounds. In particular, the oligosaccharide may be a mixture comprising a high proportion (at least 40% by weight) of one or more of the oligosaccharides cited above, in particular molasses or a dextrin.

The binder of the invention may also comprise the conventional additives given below in the following proportions, calculated on a base of 100 parts by weight of lignosulfonic acid salt and of thermosetting resin:
0 to 1 part by weight of silane, in particular an aminosilane, preferably 0.1 to 0.5 parts; and
0 to 5 parts by weight of a silicone, a vegetable oil or a fluorinated compound, preferably 0.1 to 1 part.

The role of additives is known and will be briefly summarized here: the silane is a coupling agent between the fibers and the binder and also acts as an anti-aging agent; the silicone, vegetable oil or fluorinated compound are water repellents that function to reduce absorption of water by the mineral fiber mat.

The binder is in the form of a solution, an emulsion or an aqueous dispersion.

The binder is intended to be applied to fiber mats of any nature, whether mineral and/or organic, preferably mineral. The present invention also provides mats of fibers bonded by the binder of the invention.

The mineral fibers may be constituted by glass or a rock, in particular basalt, preferably glass.

Conventionally, the binder is deposited on the mineral fiber mat (formed by the dry or wet procedure), then the mat is treated at a temperature that allows curing of the binder, which then becomes infusible. Curing of the binder of the invention is carried out at a temperature comparable to that of a conventional resin containing formaldehyde, which is generally in the range 200° C. to 220° C., and for a very short duration, of the order of a few seconds to 1 minute.

The mineral fibers can be filaments as well as threads composed of a multitude of filaments bound together, in particular using a size, and assemblies of such threads.

Thus, in a first embodiment, the mineral fiber mat is composed of discontinuous mineral filaments with a length that can be up to 150 mm, preferably in the range 20 to 100 mm and advantageously in the range 50 to 70 mm, and with a diameter that may vary widely, for example from 5 to 30 μm.

In a second embodiment, the mineral fiber mat is composed of mineral threads.

The mineral threads may be threads composed of a multitude of mineral filaments (or base threads) or of said base threads assembled into rovings.

The threads cited above may be untwisted threads or twisted (textile) threads, preferably untwisted.

The mineral threads, in particular glass, are generally cut to a length that may be up to 100 mm, preferably in the range 6 to 30 mm, advantageously 8 to 20 mm and more preferably 10 to 18 mm.

The diameter of the glass filaments constituting the threads may vary widely, for example from 5 to 30 μm. In the same manner, there may be large variations in the linear density of the thread, which may be from 34 to 1500 tex.

The glass constituting the filaments may be of any type, for example C, E, R or AR (alkali-resistant). C glass is preferred.

The organic fibers may be synthetic fibers or natural fibers.

Examples of synthetic fibers that may be cited are fibers based on an olefin such as polyethylene or polypropylene, an alkylene polyterephthalate such as ethylene polyterephthalate, or a polyester.

Examples of natural fibers that may be cited are vegetable fibers, in particular cotton, coconut, sisal, hemp or linen, and animal fibers, in particular silk or wool.

If necessary, the mat may be reinforced with continuous fibers that are generally deposited on the mat conveying device, in the direction of advance of the mat, and distributed over all or a portion of the width of the mat. Such fibers are generally deposited in the thickness of the mat of fibers, especially mineral, before application of the binder.

The reinforcing fibers may be mineral and/or organic fibers of the same chemical nature as the fibers cited above constituting the fiber mat of the invention.

Glass reinforcing fibers are preferred.

The mat of fibers, in particular mineral, generally has a mass per unit area in the range 10 to 1100 g/m², preferably 30 to 350 g/m², advantageously 35 to 60 g/m².

The binder generally represents 5% to 40% of the weight of the mat of fibers, in particular mineral, preferably 10% to 30%.

As a general rule, the fibers constituting the mat of the invention are constituted by more than 50% by weight mineral fibers, preferably more than 75% and advantageously 100%. Particularly preferably, the fibers are formed from glass.

Although it is more particularly intended for the production of roofing membranes, the mineral fiber mat of the present invention may also be used in other applications, for example as a coating, for painting or otherwise, for application to walls and/or ceilings, as a surface coating or for joining plaster or cement panels, as a surface coating for thermal insulation and/or sound insulation products such as a mineral wool or a foam intended more particularly for the insulation of roofs, or to produce a floor covering, in particular an acoustic sub-layer.

Using a mat in accordance with the present invention as a surface coating for insulation products based on mineral wool has proved to be particularly advantageous.

The following examples serve to illustrate the invention without in any way limiting its scope.

In these examples, the breaking stress of a 5 cm×25 cm sample fixed by one end to a draw rig was measured at a continuous elongation of 40 mm/minute. The breaking stress was expressed in N/5 cm.

The breaking stress was measured after (initial) manufacture and after the sample had been treated in water at 80° C. for 10 minutes. The results are expressed as the percentage retention, which is equal to: (breaking stress after treatment/initial breaking stress)×100.

### EXAMPLES 1 TO 10

a) Preparation of Binders

Binders comprising the constituents appearing in Table 1 were prepared, the proportions being expressed in parts by weight of solid matter. The phenol-formaldehyde resin was obtained by reaction of formaldehyde and phenol (formaldehyde/phenol molar ratio equal to 3.2) in the presence of catalyst (NaOH; 6% by weight relative to the phenol). The resin was then neutralized at pH 7.3 with sulphamic acid.

70 parts by weight of the phenolic resin and 30 parts by weight of urea were mixed. Water was added to the mixture so as to obtain a content of dry matter equal to 30%.

The content of solid matter (dry extract) of the aqueous binders was equal to 20%.

b) Manufacture of Mats

A 68 g/m² mat of C glass fibers was manufactured in a 1.3 m wide industrial unit using the dry procedure, said mat being collected in the form of a 200 m long roll. The binder was applied by curtain coating and represented 29% of the weight of the finished mat.

Two series of 5 cm×25 cm samples were cut out, one in the “machine direction” (the length being disposed in the direction of advance of the mat) and the other in the “transverse direction” (90° to the preceding direction). The results mentioned in Table 2 were calculated using the following relationship:

(BSₘ+BS)/2×(68/x)

in which

BSₘ is the breaking stress in the machine direction, in N/5 cm;

BS is the breaking stress in the transverse direction, in N/5 cm;

68 is the target grammage, in g/m²;

x is the measured grammage, in g/m².

The properties of each mat are given in Table 1.

TABLE 1

| | | | | | | | | Ex. 8 | Ex. 9 | |
|---|---|---|---|---|---|---|---|---|---|---|
| | Ex. 1 | Ex. 2 | Ex. 3 | Ex. 4 | Ex. 5 | Ex. 6 | Ex. 7 | (comp.) | (comp.) | Ex. 10 |
| Composition of binder | | | | | | | | | | |
| Ammonium lignosulfonate⁽¹⁾ | 85.0 | 75.0 | 50.0 | 75.0 | 88.9 | 80.0 | 60.0 | — | — | 70.0 |
| Resin | | | | | | | | | | |
| phenol-formaldehyde | 15.0 | 25.0 | 50.0 | 25.0 | 11.1 | 20.0 | — | 100 | — | 30.0 |
| urea-formaldehyde⁽²⁾ | — | — | — | — | — | — | 40.0 | — | 100 | — |
| Diammonium phosphate | 10.0 | 10.0 | 10.0 | 10.0 | 10.0 | 10.0 | 10.0 | — | — | — |
| Ammonium sulfate | — | — | — | — | — | — | — | — | — | 10.0 |
| Saccharose | — | — | — | 25.0 | 11.1 | — | — | — | — | — |
| Properties of microfilter | | | | | | | | | | |
| Breaking stress (N/5 cm) | | | | | | | | | | |
| initial | 153.2 | 219.8 | 226.3 | 189.1 | 126.2 | 127.2 | 130.4 | 140.7 | 136.2 | 221.7 |
| after treatment | 93.9 | 144.1 | 191.5 | 129.1 | 66.0 | 191.5 | 39.1 | 118.4 | 42.9 | 149.7 |
| % retention | 61.3 | 65.6 | 84.6 | 68.3 | 53.3 | 87.9 | 30.0 | 84.1 | 31.5 | 67.5 |

⁽¹⁾supplied by TEMBEC with reference T5
⁽²⁾supplied by DYNEA with reference Prefere ® 71400 J; solid matter: 20%

1. An aqueous binder, comprising, in parts by weight:
from 50 to 95 parts of at least one lignosulfonic acid salt;
from 5 to 50 parts of at least one thermosetting resin selected from the group consisting of a phenolic resin and a urea-formaldehyde resin; and
from 5 to 20 parts of a curing catalyst selected from the group consisting of phosphorus-comprising compounds and sulfates, per 100 parts of lignosulfonic acid salt and of thermosetting resin,
wherein the binder is suitable for a mat of fibers.

2. The binder of claim 1, wherein the at least one lignosulfonic acid salt a sodium, calcium, potassium, magnesium, or ammonium lignosulfonate.

3. The binder of claim 1, wherein the thermosetting resin is a phenolic resin that is a resol obtained by a process comprising reacting a phenolic compound and an aldehyde in the presence of a basic catalyst, in an aldehyde/phenolic compound molar ratio of greater than 1.

4. The binder of claim 3, wherein the resin is a phenol-formaldehyde resol.

5. The binder as of claim 1, wherein the urea-formaldehyde resin is obtained by a process comprising condensing urea and formaldehyde in more than one stage, in the presence of a base, in a formaldehyde/urea molar ratio of from 1.0 to 2.5.

6. The binder of claim 1, wherein the at least one lignosulfonic acid salt is at least 60% by weight of a mixture constituted by the lignosulfonic acid salt and the thermosetting resin.

7. The binder of claim 1, wherein the curing catalyst is an alkali metal hypophosphite salt, an alkali metal phosphite, an alkali metal polyphosphate, an alkali metal hydrogen phosphate, a phosphoric acid, an alkylphosphonic acid, an ammonium phosphate, or ammonium sulfate.

8. The binder of claim 7, wherein an alkali metal of the curing catalyst is sodium or potassium.

9. The binder of claim 7, wherein the curing catalyst is sodium hypophosphite or diammonium phosphate.

10. The binder of claim 1, wherein a quantity of curing catalyst is at most 20% of a weight of the at least one lignosulfonic acid salt and of the at least one thermosetting resin.

11. The binder of claim 1, further comprising greater than 0 and up to 15 parts by weight of a vinyl acetate polymer per 100 parts by weight of mixture constituted by the at least one lignosulfonic acid salt and the at least one thermosetting resin.

12. The binder of claim 11, wherein the vinyl acetate polymer is a homopolymer or a copolymer of at least one hydrophobic monomer selected from the group consisting of ethylene, propylene, butylene, styrene, and vinyl chloride.

13. The binder of claim 1, further comprising greater than 0 and up to 20 parts by weight of an oligosaccharide.

14. The binder of claim 13, wherein the oligosaccharide is saccharose.

15. The binder of claim 1, further comprising, based on 100 parts by weight of the at least one lignosulfonic acid salt and of the at least one thermosetting resin:
from 0 to 1 part by weight of silane; and
from 0 to 5 parts by weight of a silicone, a vegetable oil or a fluorinated compound.

16. A fiber-based mat comprising the binder of claim 1.

17. The mat of claim 16, further comprising mineral fibers.

18. The mat of claim 16, further comprising discontinuous mineral filaments, mineral threads comprising a plurality of mineral filaments, or mineral filament-comprising base threads assembled into rovings.

19. The mat of claim 16, wherein the mat has a mass per unit area of from 10 to 1100 g/m².

20. The mat of claim 16, wherein the binder is from 5% to 40% of the weight of the mat of fibers.

21. The mat of claim 16, wherein more than 50% by weight of the fibers are mineral fibers.

22. The mat of claim 21, wherein the fibers comprise glass.
